(19) United States
(12) Patent Application Publication
(10) Pub. No.: US 2026/0010835 A1
(43) Pub. Date: Jan. 8, 2026

(54) SLICE-BASED METHODS FOR OPTIMIZING VALIDATION AND SUBSEQUENT RETRAINING PROCEDURES OF MACHINE LEARNING MODELS

(71) Applicant: Robert Bosch GmbH, Stuttgart (DE)

(72) Inventors: Jorge Henrique Piazentin Ono, Sunnyvale, CA (US); Xin Li, Sunnyvale, CA (US); Wenbin He, Sunnyvale, CA (US); Jiajing Guo, Mountain View, CA (US); Arvind Kumar Shekar, Weissach im Tal (DE); Liang Gou, San Jose, CA (US); Liu Ren, Saratoga, CA (US)

(21) Appl. No.: 18/765,873

(22) Filed: Jul. 8, 2024

(51) Int. Cl. G06N 20/20

(52) U.S. Cl. CPC G06N 20/20

(57) ABSTRACT

Methods for a machine-learning network that provide efficient, scalable, and granular analyses during validation of a machine learning model are disclosed. Providing quantitative analysis information to machine learning experts when they are deciding how to proceed with further optimizing their given machine learning model allows for more directed procedures during edge case detection. Following the execution of a principal machine learning model using a validation dataset, a shallow learning model may be trained to provide simulations about how the principal model may be improved, or not, given different re-training scenarios. By using slice-based schemes, the validation dataset is divided into certain problematic data slices, and then, during inference of the shallow learning model, additional quantitative information about the effect on other data slices given a subsequent re-training of the principal model using a certain problematic data slice allows the ML expert to make more informed decisions.

### TECHNICAL FIELD

The present disclosure relates to techniques for validation and edge case detection of a machine learning model.

### BACKGROUND

Machine Learning (ML) has been used in a variety of critical applications, including autonomous driving, medical imaging, industrial fire detection, and credit scoring. Such applications need to be thoroughly evaluated before deployment in order to assess model capabilities and limitations. Unforeseen model mistakes may cause serious consequences in the real world: for example, a false sense of security in ML models may cause safety issues in driver assistance and industrial systems, misdiagnoses in medical analysis or treatment analysis, and biases against individuals and groups.

MLOps (Machine Learning Operations) engineers that focus on product-quality model development may need a system that has identified that the evaluation of critical ML models and may be usually conducted beyond the aggregated level (e.g., a single performance metric). Instead, it may be beneficial to thoroughly evaluate model performance on carefully specified usage scenarios or conditions to meet important ML product requirements. Based on this analysis, experts can then take actions to both attempt to make the model more robust to various conditions and make customers aware of model limitations in certain conditions, aiding in the development of mitigating measures. However, determining how to parse through such large datasets and detect relevant patterns within the data samples remains a challenge.

### SUMMARY

Machine learning (ML) applications may often undergo an iterative enhancement process to meet the necessary product requirements for model release. For instance, an object detection model for autonomous driving must perform optimally under various curated environmental conditions, such as temperature, weather, and object clutter. To achieve such quality in a model, multiple rounds of evaluation and improvement are needed. ML engineers are tasked with the continuous improvement of their models, focusing on specific conditions of interest, also referred to as data slices, until an acceptable model is achieved. However, the iterative process of optimizing ML models for data slices is both time-consuming and computationally expensive, primarily because it involves training multiple models from the ground up. To address this challenge, generalized slice boosting methods that apply shallow learning models are described herein, which are designed to estimate the performance impact of optimizing a machine learning model for a specific data slice and under specific scenarios. With generalized slice boosting methods, trade-offs between optimizing for one data slice over others may be rapidly determined, providing relevant analysis information to ML experts who would like to further fine-tune their specific machine learning model. Such generalized slice boosting techniques may be applied across different data modalities and tasks, including tabular and image data classification, and object detection.

### BRIEF DESCRIPTION OF THE DRAWINGS

FIG. 1 illustrates a system for training a machine learning model, such as a neural network, according to some embodiments.

FIG. 2 illustrates a computer-implemented method for training and utilizing a machine learning model, such as a neural network, according to some embodiments.

FIG. 3 illustrates a high-level flow diagram for validation and edge case detection of a principal machine learning model using slice-based methods, according to some embodiments.

FIG. 4 illustrates another high-level flow diagram for validation and edge case detection of a principal machine learning model using slice-based methods, according to some embodiments.

FIGS. 5A and 5B illustrate a high-level flow diagrams of generalized slice boosting techniques that may be performed during validation and edge case detection of a principal machine learning model, according to some embodiments.

FIG. 6 illustrates a flow diagram for a validation process of a principal machine learning model, wherein a shallow learning model is trained in order to provide a detailed analysis of problematic slices within the validation dataset and to propose next steps that may be selected by a user, in order to then further refine and train the principal machine learning model, according to some embodiments.

FIG. 7A illustrates a method of applying importance weighting when determining the detailed analysis shown in FIG. 6, according to some embodiments.

FIG. 7B illustrates a method of applying a group distributionally robust optimization when determining the detailed analysis shown in FIG. 6, according to some embodiments.

FIG. 8 is a flow diagram that illustrates a process of performing a generalized slice boosting technique during a validation process for a principal machine learning model, according to some embodiments.

FIG. 9 depicts a schematic diagram of an interaction between a computer-controlled machine and a control system, according to some embodiments.

FIG. 10 depicts a schematic diagram of the control system of FIG. 9 configured to control a vehicle, which may be a partially autonomous vehicle, a fully autonomous vehicle, a partially autonomous robot, or a fully autonomous robot, according to some embodiments.

FIG. 11 depicts a schematic diagram of the control system of FIG. 9 configured to control a manufacturing machine, such as a punch cutter, a cutter, or a gun drill, of a manufacturing system, such as part of a production line, according to some embodiments.

FIG. 12 depicts a schematic diagram of the control system of FIG. 9 configured to control a power tool, such as a power drill or driver, that has an at least partially autonomous mode, according to some embodiments.

FIG. 13 depicts a schematic diagram of the control system of FIG. 9 configured to control an automated personal assistant, according to some embodiments.

FIG. 14 depicts a schematic diagram of the control system of FIG. 9 configured to control a monitoring system, such as a control access system or a surveillance system, according to some embodiments.

FIG. 15 depicts a schematic diagram of the control system of FIG. 9 configured to control an imaging system, for example an MRI apparatus, x-ray imaging apparatus, or ultrasonic apparatus, according to some embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Machine Learning applications are pervasive in the contemporary world, yet their development remains a challenging task. This is in part due to the long training times and the iterative fine-tuning that these models require. Critical applications such as autonomous driving and credit scoring require Machine Learning experts to thoroughly optimize their models, prioritizing high performance in certain scenarios while accepting trade-offs in others. For example, in the case of autonomous driving and driver assistance, a machine learning model might be designed to prioritize the detection of pedestrians and curbstones, relegating the importance of other objects like small cardboard boxes. Once an initial model is trained, experts assess its performance based on meticulously defined usage scenarios or conditions, aligning these evaluations with significant machine learning product requirements. Additionally, experts may scrutinize the model's performance in other scenarios where it may be underperforming. These specific usage scenarios or conditions are referred to as “data slices.” Upon analyzing these slices, experts can then develop strategies to enhance the model's robustness to varying conditions, for instance, by assigning higher weights (or importance) to samples belonging to a crucial data slice during the training process.

The process of fine-tuning and optimizing a machine learning model requires training several models from the ground up until a suitable model is obtained. This start-from-scratch approach is both computationally demanding and time-consuming. For instance, deep neural networks may require several days or more to train, making the iteration process across numerous models highly time inefficient. In order to provide estimated improvements, or not, to an ML expert if they were to consider retraining their deep learning model based on a given problematic data slice, the present disclosure applies generalized slice boosting techniques to train a shallow learning model to make such predictions. The ML expert may then make an informed decision on whether or not to dedicate days to further optimizing their model, or whether they should consider a different type of re-optimization that corresponds to high estimated improvements. Such generalized slice boosting methods are task agnostic, and, as such, may be applied to classification, regression, object detection, or various other types of computer vision. The performance impact estimation is configured to highlight tradeoffs between data slices in a principal machine learning model without the need to retrain another, second deep learning model from scratch in order to obtain such information. Thus, the methods described herein significantly reduce the overall development time for time-consuming and complex deep learning models.

The present disclosure continues with detailing the types of machine learning models that the methods and systems described herein may be used to validate, followed by description pertaining to using generalized slice boosting techniques to provide improved methods for edge case detection and subsequent model optimizations. The present disclosure then demonstrates the versatility of the methods and systems described herein for use in validation and edge case detection of classification, object detection, and regression models.

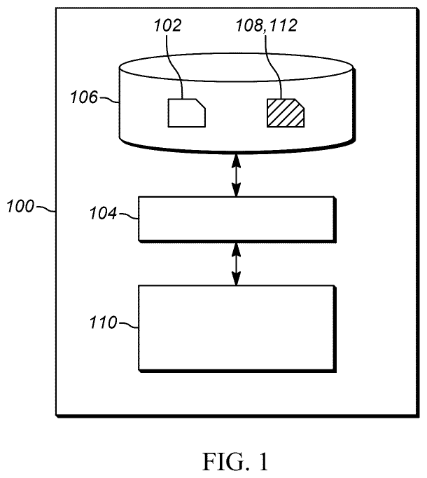

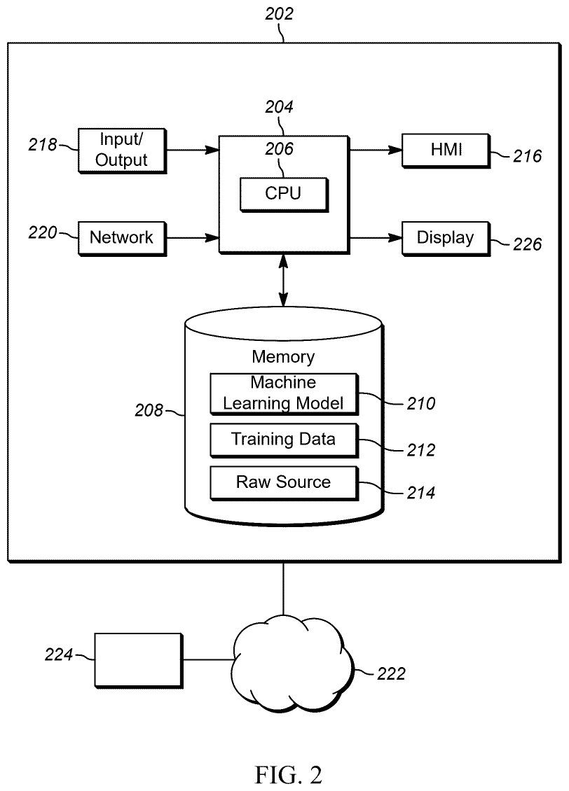

FIG. 1 illustrates a system 100 for training a machine learning model, such as a deep neural network. It should be understood that, while the example embodiments given in the following paragraphs herein with regard to FIGS. 1 and 2 refer to a deep neural network, additional embodiments of FIGS. 1 and 2 may be applied to a classification model, an object detection model, a regression model, or any other type of machine learning model that is developed, trained, and optimized for various computer vision applications.

Furthermore, and as related to the description herein, a machine learning model that is being cycled through various stages of training, validation, and further optimization may be referred to as the “principal” machine learning model. The term “principal” is used herein to define the model that is the subject of such training, validation, and optimization, as opposed to the “shallow” learning model (see also the following paragraph for additional embodiments of the shallow learning model) that is applied during slice-based analyses of the principal machine learning model. In some embodiments, the principal machine learning model may be defined as a “deep” learning model, such as a deep neural network, wherein the model has multiple hidden layers (e.g., tens or hundreds of hidden layers) in between an input layer and an output layer of the model. A deep learning model may additionally be used to describe a machine learning model that is configured to learn complex patterns and representations based on training and/or validation datasets that are used as inputs to the model. In other embodiments, the principal machine learning model may be defined as a linear or binary model, such as a logistic regression model, a linear discriminant analysis model, or a perceptron model. In yet other embodiments, the principal machine learning model may be defined as a decision-tree-based model, such as a decision tree, a gradient boosting machine, or a random forest. In additional embodiments, the principal machine learning model may be defined as a support vector network, such as a linear support vector machine, a kernel support vector machine, or a support vector classifier with polynomial kernels.

Additional embodiments pertaining to principal machine learning models are described herein with regard to machine learning model 210, machine learning model 302, machine learning model 404, principal machine learning model 502, principal machine learning model 602, and blocks 802 and 804.

Furthermore, and as also related to the description herein, a “shallow,” “simple,” and/or “weak” learning model may be defined as a model that is without many hidden layers in between an input layer and an output layer of the model. For example, a shallow neural network may contain one or a few hidden layers, in contrast to a deep neural network that may contain tens or hundreds of hidden layers. In some embodiments, shallow learning models may be defined as decision-tree-based models, such as decision trees, gradient boosting machines, or random forests. In such embodiments, as applied to the shallow learning model in particular, the decision trees represent decision trees wherein the depth of the trees is shallow, and do not require many decision-making points before making a final classification decision, or object detection decision. In other embodiments, shallow learning models may be defined as simple and/or small models, such as support vector networks (which may also be referred to as support vector machines). Examples of support vector networks may include linear support vector machines, kernel support vector machines, or support vector classifiers with polynomial kernels. In yet other embodiments, shallow learning models may be defined as shallow neural networks. Additional embodiments pertaining to shallow-learning-based machine learning models are described herein with regard to shallow model 418, shallow machine learning model training and inference 616, and block 810. Moreover, depending upon a certain application of a given principal machine learning model (e.g., classification, object detection, regression, etc.), a specific type of shallow learning model (decision tree model, shallow neural network, etc.) may be selected by the system and methods described herein in order to match needs pertaining to the certain application of the given principal machine learning model.

In some embodiments, the system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, ZigBee or Wi-Fi interface or an Ethernet or fiber optic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network (e.g., a version of the machine learning model that has yet to be trained) which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation, and a part of the input of the stack of layers. The processor subsystem 110 may be further configured to iteratively train the neural network using the training data 102 (e.g., thus generating updated versions of the machine learning model with respect to a first “untrained” version of the model). Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (“IO”) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

FIG. 2 illustrates a computer-implemented method for training and utilizing a neural network, according to some embodiments. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 214.

The computing system 202 may include a network interface device 220 that is configured to provide communication with external systems and devices. For example, the network interface device 220 may include a wired and/or wireless Ethernet interface as defined by Institute of Electrical and Electronics Engineers (IEEE) 802.11 family of standards. The network interface device 220 may include a cellular communication interface for communicating with a cellular network (e.g., 3G, 4G, 5G). The network interface device 220 may be further configured to provide a communication interface to an external network 222 or cloud.

The external network 222 may be referred to as the world-wide web or the Internet. The external network 222 may establish a standard communication protocol between computing devices. The external network 222 may allow information and data to be easily exchanged between computing devices and networks. One or more servers 224 may be in communication with the external network 222.

The computing system 202 may include an input/output (I/O) interface 218 that may be configured to provide digital and/or analog inputs and outputs. The I/O interface 218 may include additional serial interfaces for communicating with external devices (e.g., Universal Serial Bus (USB) interface).

The computing system 202 may include a human-machine interface (HMI) device 216 that may include any device that enables the system 200 to receive control input. Examples of input devices may include human interface inputs such as keyboards, mice, touchscreens, voice input devices, and other similar devices. The computing system 202 may include a display device 226. The computing system 202 may include hardware and software for outputting graphics and text information to the display device 226. The display device 226 may include an electronic display screen, projector, printer or other suitable device for displaying information to a user or operator. The computing system 202 may be further configured to allow interaction with remote HMI and remote display devices via the network interface device 220.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 214. The raw source dataset 214 may include raw or unprocessed sensor data that may be representative of an input dataset for a machine-learning system. The raw source dataset 214 may include video, video segments, images, text-based information, and raw or partially processed sensor data (e.g., radar map of objects). In some examples, the machine-learning algorithm 210 may be a neural network algorithm that is designed to perform a predetermined function. For example, the neural network algorithm may be configured in automotive applications to identify pedestrians in video images.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include source videos with and without pedestrians and corresponding presence and location information. The source videos may include various scenarios in which pedestrians are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., annotations) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), the machine-learning algorithm 210 may be executed using data that is not in the training dataset 212. The trained machine-learning algorithm 210 may be applied to new datasets to generate annotated data.

The machine-learning algorithm 210 may be configured to identify a particular feature in the raw source data 214. The raw source data 214 may include a plurality of instances or input dataset for which annotation results are desired. For example, the machine-learning algorithm 210 may be configured to identify the presence of a pedestrian in video images and annotate the occurrences. The machine-learning algorithm 210 may be programmed to process the raw source data 214 to identify the presence of the particular features. The machine-learning algorithm 210 may be configured to identify a feature in the raw source data 214 as a predetermined feature (e.g., pedestrian). The raw source data 214 may be derived from a variety of sources. For example, the raw source data 214 may be actual input data collected by a machine-learning system. The raw source data 214 may be machine generated for testing the system. As an example, the raw source data 214 may include raw video images from a camera.

In the example, the machine-learning algorithm 210 may process raw source data 214 and output an indication of a representation of an image. The output may also include augmented representation of the image. A machine-learning algorithm 210 may generate a confidence level or factor for each output generated. For example, a confidence value that exceeds a predetermined high-confidence threshold may indicate that the machine-learning algorithm 210 is confident that the identified feature corresponds to the particular feature. A confidence value that is less than a low-confidence threshold may indicate that the machine-learning algorithm 210 has some uncertainty that the particular feature is present.

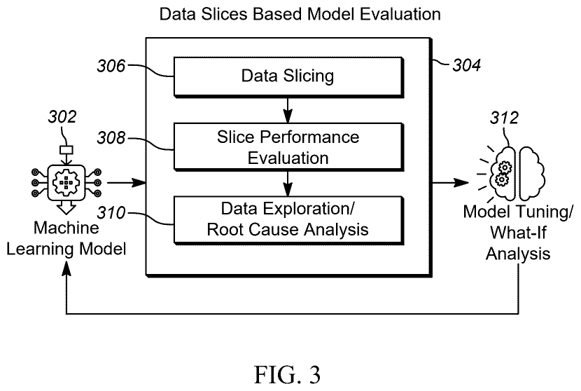

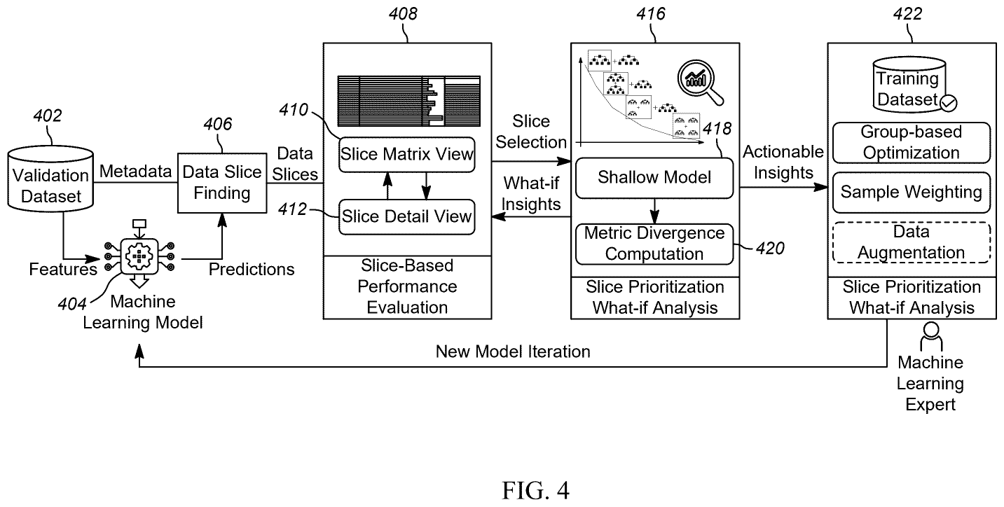

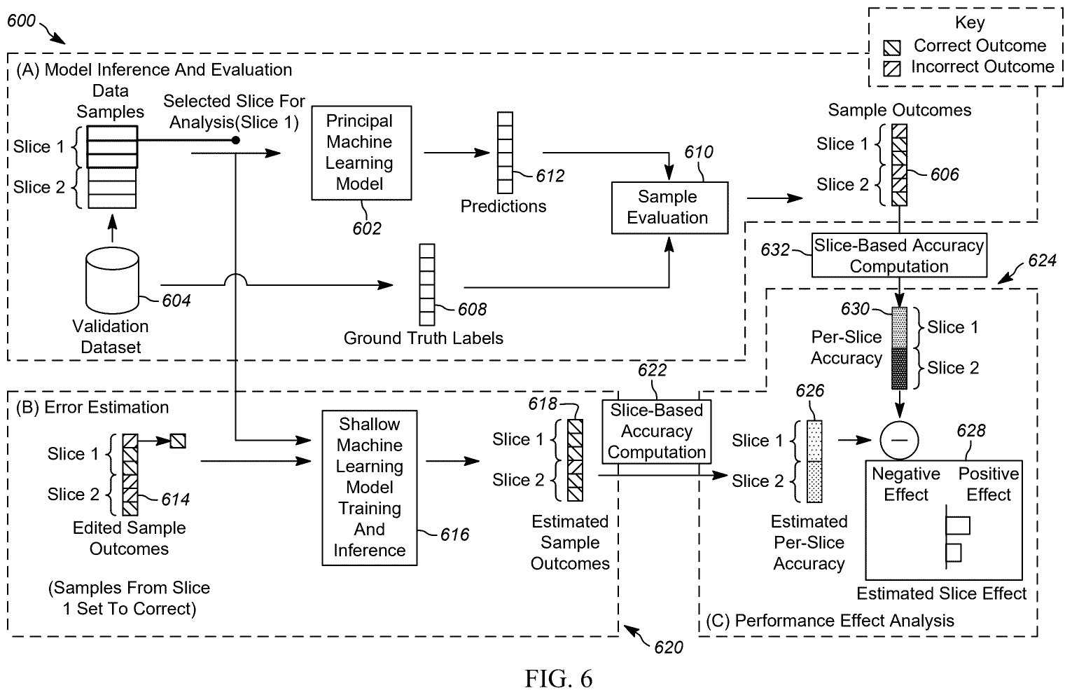

FIG. 3 illustrates an iterative flow diagram for a data slice based model evaluation 304, such as for validation and edge case detection of a machine learning model 302, according to some embodiments. The system may include a machine learning model 302, such as a classification model, an object detection model, a regression model, or any other computer vision model. As additionally defined above, machine learning model 302 may resemble a principal machine learning model that is being trained for a domain-specific application. Furthermore, FIG. 3 discloses a high-level workflow 304 for model analysis and iteration, which may otherwise be referred to herein as a validation process. Additional and detailed workflows for methods for performing validation of a machine learning model are illustrated in FIGS. 4 and 6, and further described below.

As shown in FIG. 3, data slice based model evaluation 304 may include identifying data slices within a validation dataset, as indicated in block 306. As indicated in block 308, performance metrics, guidance metrics, and additional domain-specific metrics may be determined by the system described herein in order to provide slice performance evaluation criteria to the user. In some embodiments, a user may then use such results of the validation process in order to determine root cause of certain types of limitations for the current state of the model, and further explore the data slices, as indicated in block 310. Based on such observations, the system and method may provide an indication to the user to iterate over the model, as illustrated with model tuning/what-if analysis 312 in the figure, by retraining while re-prioritizing certain data slices over others.

In various cases, users and/or ML experts may request to slice the data into various scenarios, thoroughly evaluate their models 302, understand the failure cases, and develop strategies 312 to tune the models to improve performance. As such a user-driven comparison and analysis step in block 310 of the identified data slices may itself be time consuming, the system and methods described herein are configured to provide the identified slices to the user and categorize them by error type, support, performance metric values, relative risk ratio values, etc., allowing for a more streamlined validation process that is driven by algorithmic results.

Data slicing and domain-specific needs may be different for the various environments and applications that the data and ML model is utilized for. In the context of autonomous driving, for example, ML experts may be interested in modeling the ultrasonic sensors to understand the car surroundings (see also FIG. 10 and related description herein). Such modeling may be a critical modality in the sensor-fusion pipeline to enhance the overall system robustness. The raw ultrasonic sensor data may not be directly interpretable by a human. However, every sample may also contain metadata describing the experiment setup, for example, the object type, distance, sensor location, time of day, etc. Thus, it may be beneficial to utilize a trained decision-tree-based model to classify nearby objects' heights (as “high” or “low”) using the sensor-derived tabular features. While evaluating their models, it may also be beneficial to tune and/or verify that certain critical objects have a low error rate. In some cases, it may require a trade-off between the respective performances of non-critical objects critical objects. For example, children, curbstones, and nearby cars may have the highest priority in terms of object detection. Therefore, during respective evaluation iterations, it may be important to slice the data, evaluate the model on the data subsets, and retrain the model with different parameters to mitigate the potential for critical mistakes. By providing data slices that are not only themselves relevant to edge case detection but by also providing them based on domain-specific performance metrics, the system and methods described herein provide a streamlined and efficient validation process to users.

In another example, such as in a use case for fire detection applications, it may be beneficial to train a deep neural network to detect smoke and fire based on video frames. In this scenario of training a model, the video segment may be associated with interpretable metadata that describes the video collection process in detail, such as description pertaining to the recording location, time of day, the smoke density, and whether there were blinking lights in the scene. Following initial training, the overall performance of this model may be high. However, edge case detection, using validation processes described herein, may still be essential in order to identify particular types of situations where the model failed.

FIG. 4 illustrates another iterative flow diagram for validation and edge case detection of a machine learning model. In some embodiments, FIG. 4 illustrates a process of performing validation of a machine learning model, and may be understood to be an iterative process, as indicated by the arrow in the figure labeled “New Model Iteration.” Moreover, it should be understood that the flowchart illustrated in FIG. 4 may be executed by one or more computing devices that are configured to perform the steps shown in FIG. 4. In addition to performing steps shown in the figure that collectively describe a validation process, the one or more computing devices may be further configured to provide/receive certain information to/from the ML expert or user. For example, and following the identification of a new set of data slices, the computing devices may be configured to provide the data slices and corresponding metrics to the user, such as via a user interface.

In some embodiments, a validation dataset 402 may be an input to the overall system that is shown in FIG. 4. The validation data may include raw images or tabular features extracted from sensor signals (see also examples of sensor signals described with respect to FIGS. 10-15). Furthermore, metadata (e.g., interpretable features that may be utilized to slice the data), and ground truth labels (e.g., object classes or obstacle height) may also be used as inputs to the validation process. In the methods described herein, validation datasets, such as validation dataset 402, are used within a validation dataset rather than a training dataset. Furthermore, as ground truth labels exist for the corresponding data samples within the validation dataset, the validation process itself may be considered as a supervised learning technique. Moreover, depending upon the specific type of machine learning model that is being validated, the validation dataset may include image information, tabular information, radar information, sonar information, or sound information.

The system described herein then uses a slice finding algorithm 406 to identify data slices where the performance measures or metrics (e.g., accuracy) are the most different from the overall model performance. In one example, the slice finding algorithm 406 may be a DivExplorer algorithm, which may be a Frequent Pattern Mining-based approach for such a task. The metadata from the validation data set 402 may be utilized by the data slice finding algorithm 406. Furthermore, the machine learning model 404 may identify predictions based on the features from the validation dataset 402. The machine learning model may then provide the predictions to data slice finder 406. Data slicing is additionally illustrated in FIG. 6 and further described in the corresponding description herein.

Following a process of identifying data slices, the data slicing algorithm 406 may then output the data slices to a slice-based performance evaluation 408. The slice-based performance evaluation interface 408 may include an interface or tool that is output on a display (e.g., computer, tablet, phone, or remote display). The evaluation interface 408 may include a slice matrix view 410. Thus, the system may allow users to quickly visualize and summarize the identified data slices using the slice matrix view 410. The slice matrix view may display where rows correspond to slices, and columns, to slice descriptions and associated metrics. The user may be able to select slices to view its details using a slice detail view 412 or some other slice distribution view. The slice detail view 412 may output, on an interface, present metadata distributions and correlations to the user. Both the matrix view and the detail view may output and allow the user to identify critical slices in the data, such as slices where the model performance has issues (e.g., false positive errors, false negative errors, etc.). Thus, the user may be able to select and identify various data and statistics associated with a particular slice that corresponds to be a specific attribute (e.g., in a case of image recognition, bald men.)

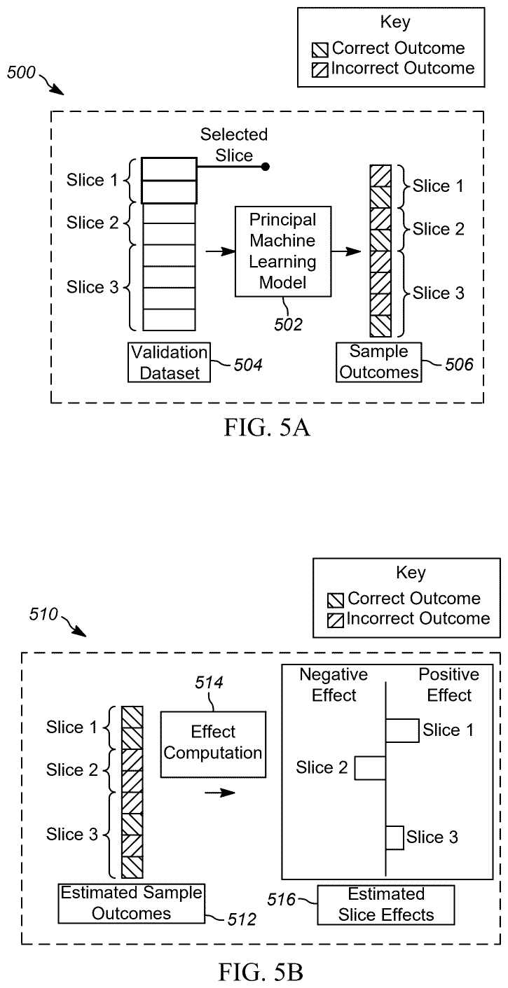

Upon a user selecting a specific slice, the user may utilize a test mitigating tool that is configured to adjust various parameters of the system (e.g., including ML model 404) to show a resulting effect to the adjustment. For example, when a critical slice is found, the user can test mitigating measures using a “Slice Prioritization-What-If Analysis” tool 416. The analysis tool 416 may utilize an algorithm, such as a shallow model 418, to evaluate the effect of optimizing the model for particular data slices. The algorithm may fit a shallow model 418 on top of the original model to estimate the effect of prioritized optimization. The shallow model 418 may be utilized to approximate the residual (e.g., errors) of the slices. The shallow model 418 may also be trained. Further description pertaining to the application of a shallow learning model is described with regard to FIGS. 5A-8 herein.

Upon a user finding a group of slices to optimize, they may have the ability to export the selected slices back to their programming environment, make changes on data, hyperparameter, or model, and insert the new model back into the system (e.g., via a visual interface of the system) to compare models, as indicated in block 422.

The system may output information to a ML expert to help modify the system for improvements on a specific application, such as fire detection or autonomous driving. In one example, in order to mitigate the problems found in the data slices, the expert strategy may attempt to increase the training dataset size, using data collection and data augmentation. To improve particular data slices, the ML expert may collect more samples in the same conditions of the slices of interest. They may then thoroughly inspect the new samples in order to ensure data quality. Another mitigation strategy that may be applied is data augmentation. For example, an ML expert may test different augmentation strategies, such as including frames with added noise and blur to their training dataset.

FIGS. 5A and 5B illustrate a high-level flow diagrams of generalized slice boosting techniques that may be performed during validation and edge case detection of a principal machine learning model, according to some embodiments.

In some embodiments, FIGS. 5A and 5B demonstrate moments in time during an overall workflow for evaluation of a principal machine learning model. For context, it may be assumed that, prior to the moment in time shown in FIG. 5A, data slices corresponding to data samples within the validation dataset have been determined, such as by using a slice-finding algorithm introduced above, For example, in the context of autonomous driving, data slices may be defined by certain attributes associated with the data samples, such as object type (e.g., “car”, “cone”, “tree”, “curbstone”, etc.), weather (e.g., “sunny”, “cloudy”, “rainy”, etc.) and temperature (e.g., “high”, “mid”, and “low”). After identifying a given problematic data slice within the validation data (e.g., [object=“curbstone”, weather=“rainy”]), the ML expert may decide that they would like to retrain the principal machine learning model to fix this particular data slice problem. However, retraining the principal machine learning model may be extremely time-consuming or otherwise costly, and the ML expert may first like to predict whether or not retraining the full principal machine learning model based on data samples within this particular problematic data slice would actually quantifiably improve their principal machine learning model. In order to evaluate such types of trade-offs in a much less time-consuming manner, and prior to launching the subsequent retraining of the principal machine learning model, a shallow learning model may be trained based on generalized slice boosting techniques in order to provide quantitative estimations of the predicted improvement, given a certain retraining scenario.

As shown in model validation 500 of FIG. 5A, validation dataset 504 is input to principal machine learning model 502 and is used to generate predictions, or sample outcomes 506, based on respective ones of the data samples within each slice. As shown in the Key of the figure, “correct outcomes” and “incorrect outcomes” may be determined by comparing the generated predictions of the principal machine learning model against ground truth labels that correspond to the data samples of the validation dataset 504. In the particular illustration shown in FIG. 5A, the ML expert has identified Slice 1 as a problematic data slice that they would like to retrain principal machine learning model 502 on, but they would like to first understand whether or not that would be a productive optimization on their model to attempt.

As shown in generalized slice boosting methods 510, a shallow learning model is trained estimate that, under the ideal scenario where the optimization model correctly fits to selected Slice 1, what will be the outcome on samples belonging to other slices. The prediction target of the shallow learning model is engineered to be the outcome of the sample prediction (e.g., correct/incorrect outcome). To focus on the effect estimation of Slice 1, the sample outcomes of data samples in Slice 1 are modified to “correct outcomes,” as shown in estimated sample outcomes 512. The sample-level residual predictions are then aggregated to obtain slice-level estimation results, providing a quantitative analysis to help determine how the accuracy and/or other slice-specific performance metric will increase or decrease if the ML expert proceeds with a retraining of the principal machine learning model.

Continuing with the particular illustration shown in FIGS. 5A and 5B, the ML would be presented with the quantitative analysis that, if they were to proceed with further optimizing their principal machine learning model on a training dataset that includes data samples of Slice 1 or similar types of data samples, then it would most likely have a positive effect on Slice 3 but a negative effect on Slice 2.

FIG. 6 illustrates a flow diagram for a validation process of a principal machine learning model, wherein a shallow learning model is trained in order to provide a detailed analysis of problematic slices within the validation dataset and to propose next steps that may be selected by a user, in order to then further refine and train the principal machine learning model, according to some embodiments.

As shown in FIG. 6, a method of evaluating a principal machine learning model may include, for each iteration, three key portions of the overall process. In a first portion described as model inference and evaluation 600, a validation dataset 604 is provided to principal machine learning model 602. Validation dataset 604 includes a plurality of data samples and corresponding ground truth labels 608, in addition to any type of attributes, metadata, and/or features that are associated with the respective data samples. As part of an execution of principal machine learning model 602, the model is configured to generate predictions 612 associated with the data samples of validation dataset 604.

Then, and as also illustrated in model inference and evaluation 600, ground truth labels 608 are compared to predictions 612 in sample evaluation 610 in order to determine sample outcomes 606. When determining sample outcomes in sample evaluation 610, the computing devices that are configured to perform actions shown in FIG. 6 may determine a “correct outcome” when a given prediction, generated by principal machine learning model 602, matches the corresponding ground truth label 608. This may also be referred to as a “correct prediction,” according to some embodiments. The computing devices may determine an “incorrect outcome” when the given prediction, generated by principal machine learning model 602, does not match the corresponding ground truth label 608. This may also be referred to as an “incorrect prediction,” according to some embodiments.

As additionally shown in FIG. 6, portions of the data samples within validation dataset 604 may be categorized into data slices, wherein a given data slice shares at least one common attribute, feature, or other metadata across two or more data samples. For example, “Slice 1” in FIG. 6 includes three data samples that share at least one common attribute, feature, or other metadata. It should be understood that, for simplicity of discussion, validation dataset 604 has been portioned into two data slices, namely “Slice 1” and “Slice 2.” However, this should not be misconstrued as limiting as to the number of data slices that may be determined via slice finding techniques introduced in FIG. 4 herein.

Continuing with the first portion of an overall method of evaluating a principal machine learning model, model inference and evaluation 600 additionally demonstrates “Slice 1” includes one incorrect outcome and two correct outcomes, while “Slice 2” includes two incorrect outcomes and one correct outcome. In some embodiments, information pertaining to the slices may be provided to an ML expert in order to begin an analysis of certain problematic slices and/or mistakes that the principal machine learning model 602 is currently making. For example, the ML expert may determine that Slice 1 largely pertains to a false negative error that the model is making between certain types of attributes, etc. The ML expert may then want to estimate a predicted benefit, or not, of retraining principal machine learning model 602 on a training dataset that is targeted towards data samples in Slice 1 or that are similar to the data samples in Slice 1.

In order to provide such types of quantifiable predictions to the ML expert, the systems and methods described herein may be configured to perform error estimation 620, followed by performance effect analysis 624. In the following paragraphs, a particular example of a scenario in which the ML expert would like to estimate a predicted benefit to other slices within validation dataset 604 if the principal machine learning model were to be retrained based on data samples within Slice 1. It should be understood that error estimation 620 and performance effect analysis 624 may be repeated for other scenarios, such as the predicted benefit to Slice 1 if the principal machine learning model were to be retrained based on data samples within Slice 2, or the predicted benefit to Slices 1 and 2 if the principal machine learning model were to retrained based on data samples within Slice 3, 4, etc.

In a second portion of the overall method of evaluating the principal machine learning model, error estimation 620 describes a process of training a shallow machine learning model 616 in order to predict the quantifiable benefit, or not, of retraining the principal machine learning model 602 based on data samples in Slice 1. Inputs to shallow machine learning model training and inference 616 include an edited version of the determined sample outcomes 606, wherein the sample outcomes of Slice 1, in this particular example, are all reset to a “correct outcome.” As shown in the figure, sample outcomes of Slice 1 within the total sample outcomes 606 include one incorrect outcome and two correct outcomes. In the modified version within error estimation 620, the one incorrect outcome is reset to a correct outcome. The two incorrect outcomes and one correct outcomes of Slice 2 remain the same.

As shown in estimated sample outcomes 618, following the training and inference of shallow machine learning model 616, Slice 1 still contains three correct outcomes, and now Slice 2 includes two correct outcomes and only one incorrect outcome, as opposed to before, wherein Slice 2 included two incorrect outcomes and only one correct outcome. This predicted change with regard to correct/incorrect outcomes in slices besides the selected Slice 1 provides quantifiable information to the ML expert in order to help them determine whether to retrain the principal machine learning model based on the selected Slice 1. In this particular example, shallow machine learning model 616 estimates that there will be one less incorrect outcome within Slice 2 if principal machine learning model 602 is retrained based on data samples within Slice 1.

As introduced above within the description of FIG. 1, shallow machine learning model 616 may resemble any type of shallow, simple, or small model (e.g., a shallow neural network, a support vector network, a random forest decision tree model, a gradient boosting decision tree model, etc.) that takes orders of magnitude less time to train than a principal machine learning model (e.g., a deep neural network).

In a third portion of the overall method of evaluating the principal machine learning model, performance effect analysis 624 describes a process of computing various quantifiable positive, negative, or neutral effects onto other slices if the principal machine learning model were to be retrained on Slice 1. Slice-based accuracy computation 632 determines a per-slice accuracy based on sample outcomes 606, while slice-based accuracy computation 622 determines a per-slice accuracy based on estimated sample outcomes 618. Those values are compared, as shown by the subtraction sign in the figure, in order to produce estimated slice effect 628. As slice outcomes within Slice 1 have been modified to all reflect correct outcomes, there is a strong positive effect for Slice 1 on a retraining of Slice 1. As additionally shown, shallow machine learning model 616 also estimates an improved slice-based accuracy on Slice 2 if the principal machine learning model 602 were to be retrained on data samples within Slice 1. If it were estimated by shallow machine learning model 616 that retraining principal machine learning model 616 on data samples within Slice 1 would negatively affect Slice 2, then estimated slice effect 628 would show a negative effect. Similarly, if it were estimated by shallow machine learning model 616 that retraining principal machine learning model 616 on data samples within Slice 1 would have little to no impact on Slice 2, then estimated slice effect 628 would show a no horizontal bar, or some other visual interpretation of a net neutral effect.

In some embodiments, information within estimated slice effect 628 may be provided to the ML expert via a user interface. Based on the estimated positive, negative, or neutral effects shown in estimated slice effect 628, the ML expert may decide to proceed or not with retraining principal machine learning model 602 on Slice 1, following with the on-going example.

In some embodiments, a generalized slice boosting method, such as that which is shown in FIG. 6, may also be described by the algorithmic definitions in the following paragraphs. A generalized slice boosting method may be defined as a task-agnostic method, as it may be used to estimate the effect of data-slice based model optimizations in classification, regression, and object detection models, vastly increasing the applicability of such validation and edge case detection methods with respect to previous methods for performing validation of a principal machine learning model.

An algorithmic form of the generalized slice boosting method may be defined as follows: Suppose an ML expert would like to optimize a first principal machine learning model for a particular data slice, S. Instead of training another, second principal machine learning model to evaluate slice trade-offs if the ML expert were to proceed with optimizing the first principal machine learning model, a shallow classification model may be trained to approximate the outcome of all the samples in the validation dataset (e.g., each sample is classified as 1—correct or 0—incorrect, or some other binary form of representation). To estimate the effect of improving a particular data slice, the predictions of the selected slices S are modified to be correct (1) during the training process. Once the new shallow learning model is trained (e.g., wherein the training process of the shallow learning model takes on the order of seconds or minutes rather than days weeks), the shallow machine learning model is evaluated on the same data to obtain an estimate of how the change of making slice S affects the other data samples within the validation dataset. In other words, the shallow learning model may be applied in order to assess how the principal machine learning model would perform on the other data slices by evaluating their accuracy and using the approximated, shallow learning model. There are three possible results (see also estimated slice effect 628): i) the principal machine learning model, if retrained, would not change the prediction outcome at all (e.g., the shallow learning model would estimate that there would be a net neutral effect); ii) it would estimate an improvement in the prediction results (e.g., the shallow learning model would estimate that certain mistakes that the principal machine learning model was previously making in terms of false positive errors, false negative errors, etc. would be fixed); or iii) it would estimate a negative impact on the prediction scores (e.g., the shallow learning model would estimate that certain mistakes that the principal machine learning model was previously making would not be fixed, would worsen, or would cause additional new mistakes to be made).

The slice-based accuracies are computed on top of the estimated outcome, which may then be used to estimate the effect of the actual principal machine learning model optimization on the data slices. Because the shallow learning model is “shallow,” the training process is much faster than training an entire principal machine learning model from scratch.

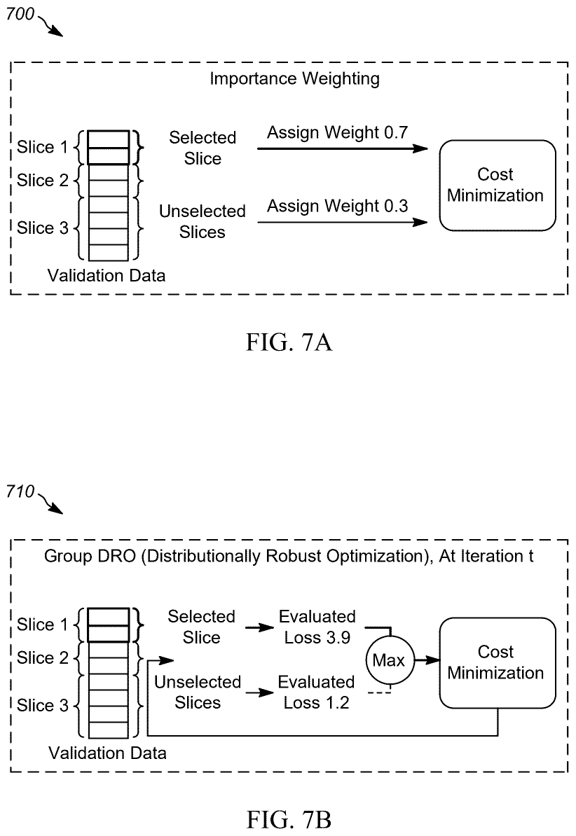

The generalized slice boosting algorithm may be further defined by the following: Denote the original principal machine learning model as f, parameterized by θ. Let the training data be X^{train} ∈ [symbol] ^{N}^{^{train×}}^{D}, wherein N^{train} is the number of data samples in the training set and D is the feature dimension. Similarly, let the validation data be X^{val} ∈ [symbol] ^{N}^{^{val}}^{×D}. Then, S^{val} is used to denote the data slices to be optimized by the ML expert, and S^{train} is used to denote the training data slices that correspond to the same description as S^{val} (e.g., Weather=Sunny, Object=Wall). Further optimization approaches, such as those described with regard to FIGS. 7A and 7B herein, may also be used to retrain f on X^{train} in order to prioritize on S^{train}, and in order to obtain the optimized model f′. However, due to the scale of X^{train} and the high complexity of f, the optimization is time-consuming. It may therefore be infeasible to try out different slice combinations to obtain the optimal f′ that could satisfy the product requirements.

To facilitate fast slice-based experimentation, one of the main objectives is to estimate the performance difference between f′ and f, using a generalized slice boosting method, and without explicitly training for f′. Instead of training a full principal machine learning model to evaluate slice trade-offs, a shallow learning model is trained in order to approximate the outcome of the data samples inside the data slices (e.g., whether the samples are correct—1 or incorrect—0). In the description that follows, the shallow learning model is denoted as h. Due to the shallow decision making limitations of the shallow learning model, the training process of the shallow learning model is significantly faster than the training of another, second principal machine learning model, which would have to be trained from scratch.

In the following continuation of description pertaining to a method for generalized slice boosting, there are two assumptions: i) The validation dataset X^{val} has a similar distribution to the training dataset X^{train}, while being significantly smaller. This allows for the shallow learning model to be trained the validation set to approximate the full principal machine learning model behavior on the training set. This assumption is valid in most cross-validation experiment settings. ii) The shallow learning model can estimate sample outcomes correctly and with high accuracy. Under these assumptions, the shallow learning model is trained based on receiving, as inputs, features or metadata from the validation set, and predicting the outcomes of the data samples of the validation data (e.g., whether they are correct—1 or incorrect—0). The training labels are edited for the shallow learning model so that every sample belonging to S^{val} has a label “correct”. The edited outcomes are denoted by O′. This will bias the shallow learning model towards learning that samples belonging to this slice, as well as similar samples, should be estimated to be correctly predicted by a new principal machine learning model that prioritizes S^{val} during supplemental/subsequent training iterations.

As introduced above, the shallow learning model used in the generalized slice boosting method is a “weak learner”, and therefore cannot learn deep features from the original data, like a deep neural network would. In order for the shallow learning model to be able to learn the sample outcomes, it should be provided with adequate features for the task. Three approaches to selecting appropriate features for the shallow learning model are thus proposed in the following:

i) Metadata features. In some embodiments, a validation dataset contains data samples and associated metadata about the data samples, and this may be applied in order to train the shallow learning model and conduct the generalized slice boosting analysis. Let Z^{val} be the metadata associated with the validation dataset, h be the shallow learning model, and O′ be the edited sample outcome (e.g., modified sample outcomes containing the sample outcomes for every data sample in the validation dataset, with the change of samples belonging to S^{val} are set to “correct”). In this case, h is trained such that h(Z^{val})≈O′.

ii) Sample-level embedding features. In some embodiments, a second, pre-trained deep learning model may be applied in order to extract features from the data samples, and then use those features to train the shallow regression model. For example, in the image domain, a pre-trained deep learning model, such as DINO V2, may be applied to generate the sample-level embedding features for each data sample in the validation dataset. Let E^{val} be the sample-level embedding of the validation data samples, concatenated as a matrix. In this case, h is trained such that h(E^{val})≈O′.

iii) Detection-level embedding features. In some embodiments, such as for the investigation of the prioritization of data slices in image-based object detection models, features are extracted from the object detections themselves, not the image-level features. In such embodiments, the feature extraction may be defined as a two-step process. Firstly, a given one of the images is cropped to display some amount of environmental surroundings in the neighborhood of the detections (e.g., some constant margin may be added to the detection region to increase the size of the cropped region). Secondly, a second, pre-trained deep learning model may be applied in order to extract features from the cropped image region, for example, using DINO V2. Let N^{val} be the detection-level embedding of the cropped regions of the object detections. In this case, h is trained such that h(N^{val})≈O′.

In some embodiments in which h represents a shallow classification model, a library and corresponding parameters, such as the XGBoost library, may be used. The parameters of the classifier may be fine-tuned by setting the “number of estimators” to 10 and the “max depth” to 5, for example. These parameters may be further tailored to improve the estimation accuracy as well as the interactive response times for the what-if analysis introduced in FIG. 4.

Using any of the three methods described just above for selecting appropriate features for the shallow learning model, h is trained, and the performance improvement of the data slice optimization may then be estimated as follows:

Firstly, the computing devices that are configured to perform such actions may be further configured to compute the predicted sample outcomes for all data samples within the validation dataset. The results contain 1 if the given sample is estimated to be correctly predicted, and 0 if it is estimated to be incorrectly predicted:

prediction sample outcomes=h(X^{val})

After obtaining the estimated outcomes, the new accuracy in each slice may be determined (e.g., slice-based accuracy computation 622), and then compared with the original principal machine learning model accuracy (e.g., slice-based accuracy 632) to determine final estimated effect (e.g., estimated slice effect 628). Let A be the vector containing the accuracy of the original principal machine learning model on all data slices, and let A′ be the vector containing the accuracy of the boosted shallow learning model f′ on all data slices. The estimated effect E′ is given by E′=A′−A. As illustrated in FIG. 6, a positive quantitative value in the estimated effect indicates that the performance on the slice is estimated to improve with further optimization of the principal machine learning model, according to that particular retraining scenario of the principal machine learning model. A negative quantitative value indicates that the performance on the slice could be reduced with further optimization of the principal machine learning model, according to that particular retraining scenario of the principal machine learning model.

As such methods for generalized slice boosting utilize information about the metadata and/or embeddings, along with the sample outcomes themselves, such techniques may be applied to many machine learning domains, including classification, regression, or object detection.

The methods for applying generalized slice boosting techniques introduced above may additionally be applied using the following two types of model optimization methods for improving performance on the data slices of interest, while minimizing the trade-off for the averaged, shallow learning model performance on the entire dataset. Such methods adapt the loss function based on identified slice prioritization, and subsequently perform additional training on the shallow learning model in order to steer the shallow learning model towards the user/ML expert requirement. The following two additional methods, illustrated in FIGS. 7A and 7B, focus on optimization-based model improvements without any change of the given dataset. The framework described herein, however, is also compatible with a data-centric model improvement strategy, wherein there is additional data collection and data augmentation or synthesis.

FIG. 7A illustrates a method of applying importance weighting when determining the detailed analysis shown in FIG. 6, according to some embodiments. In some embodiments, an importance weighting method changes the loss function by assigning heavier weights to the training samples that are provided to the shallow learning model within the worst-performing slices. Importance weighting may also be described as applying an importance weighting that is biased towards the data samples within the given selected slice (e.g., selected Slice 1 in the illustration shown in FIG. 6).

In some embodiments, importance weighting modifies the expected loss by emphasizing training samples that are provided to the shallow learning model and that belong to the slices S^{train}, as shown in block 700. Denote the number of data samples in S^{train} as n^{train}, the number of data samples in the training set as N^{train}, and the total number of slices as M. The weight for slice S may then be calculated as:

$${W}_{{S}^{train}} = \frac{{N}^{train}}{M \times {n}^{train}}$$

Thus, the selected slices with lower performance correspond to the minority groups in the training set. The weights of the data slices may therefore be specified as inversely proportional to the respective slice size. Then, the modified expected loss is defined as follows:

$${E}_{( {x}^{t r a i n} , {y}^{t r a i n} , {S}^{t r a i n} )} ∼ P [ {W}_{{S}^{t r a i n}} l ( θ ; ( {x}^{train} , {y}^{train} ) ) ] ,$$

wherein P is the distribution of training data, and X^{train} and l is the loss.

FIG. 7B illustrates a method of applying a group distributionally robust optimization (Group DRO) when determining the detailed analysis shown in FIG. 6, according to some embodiments. Group DRO prioritizes the worst-performing slices during the training process.

In comparison to importance weighting, wherein selected slices are up-weighted by a heuristic rule, Group DRO adopts a different optimization scheme. Instead of optimizing for the averaged loss over entire training data, Group DRO optimizes for the worst-case loss over the groups in the training data, as shown in block 710. Specifically, the expected loss is defined as:

$${max}_{{S}^{t r a i n}} {E}_{( {x}^{t r a i n} {y}^{t r a i n} {S}^{t r a i n} ) ∼ {P}_{{S}^{train}}} [ l ( θ ; ( {x}^{train} , {y}^{train} ) ) ]$$

During training, the optimization can be conducted by either recording the historical losses of all groups, or utilizing gradient ascend. In some embodiments, gradient ascent is a method that is configured to (figuratively) point in the direction of the steepest ascent while having a numerical output from one point.

In the following paragraphs, examples of generalized slice boosting methods, using a shallow learning model, that are applied during validation of a principal machine learning model are provided. In the first example, an investigation of bias and AI fairness within an image classification domain is discussed. In the second example, an identification and mitigation of a height classification model for autonomous driving applications is discussed. In the third example, an identification or problematic data slices within an object detection domain is discussed.

In the first example pertaining to the investigation of bias and AI fairness within an image classification domain, an ML expert may train a classification model (e.g., ResNet50) to predict hair color (e.g., gray, not gray) from portraits, and obtained an overall validation accuracy of 0.98. Each image sample in the dataset may then be associated with 40 metadata attributes, including “gender”, “skin color”, “smiling”, “double chin”, “wearing necktie,” etc. The ML expert then uses a slice finding algorithm (see also slice-based performance evaluation 408 herein) to identify the problematic data slices, and estimate the performance effect of model optimization on the problematic data slices using generalized slice boosting methods described herein.

In the second example pertaining to the identification and mitigation of the height classification model for autonomous driving applications, an Industry MLOps (Machine Learning Operations) team trains a classification model to predict object heights based (e.g., high or low) on ultrasonic sensor data (e.g., Model_1), and obtains a validation accuracy of 0.88. In the particular example, every sample in the dataset contains associated metadata about the environmental and sensor conditions, including “Object Type”, “Distance”, “Sensor Approach”, “Scene Clutter”, “Direction”, “Speed”, “Temperature” and “Weather”. The MLOps team then uses a slice finding algorithm to identify problematic data slices and evaluates an agreement score on the top 5 worst data slices.

In the third example pertaining to an identification or problematic data slices within an object detection domain, an industry ML engineer is training an object detection model to detect traffic lights in street photos. The object detection model takes, as input, images, and outputs detection boxes (e.g., 4 coordinates: [x, y, width, height]) plus the class of the detection. The ML engineer may use a public dataset, such as CityScapes, to train this particular model. In this particular example, the dataset contains information about the location of the traffic lights, but no additional metadata about them. Therefore, the ML engineer uses a slice finding algorithm to find data slices based on the bounding box information, in combination with the area information (e.g., box width×height). In three of the given slices, traffic lights are detected at the bottom of the image, small traffic lights are detected on the right side of the image, and small traffic lights are detected, respectively. If the ML engineer would like to optimize the given model for these three slices, they may use generalized slice boosting techniques, such as those described herein, to estimate what improvements they could achieve.

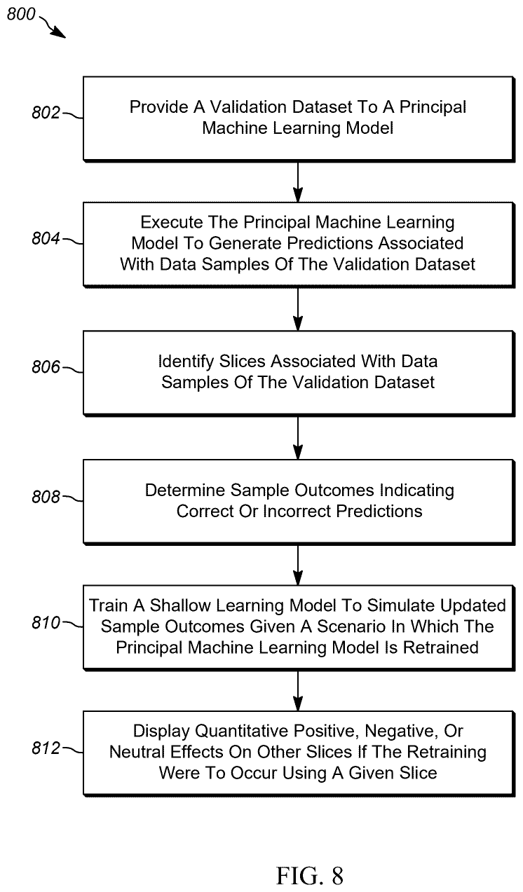

FIG. 8 is a flow diagram that illustrates a process 800 of performing a generalized slice boosting technique during a validation process for a principal machine learning model, according to some embodiments.

In some embodiments, a validation dataset is provided to a principal machine learning model, in block 802, and the principal machine learning model is executed, in block 804, in order to generate predictions associated with data samples of the validation dataset. Such a procedure may be defined as a first process within an iteration of edge case detection and evaluation of a principal machine learning model.

In block 806, a slice finding algorithm is used to identify data slices associated with various data samples within the validation dataset wherein the principal machine learning model is currently performing poorly (e.g., false positive types of errors, false negative types of errors, etc.). Sample outcomes are then determined, in block 808, for each of the data samples within the validation dataset, wherein it is determined whether or not the prediction, generated by the principal machine learning model, is a correct outcome based on ground truth labels of the validation dataset.

In some embodiments, a shallow learning model is then trained, in block 810, in order to estimate the improvement, or not, to other data slices if an ML expert were to decide to retrain the principal machine learning model based on one of the problematic data slices. During inference of the shallow learning model, such quantitative positive, negative, or neutral effects onto the other slices are determined and then displayed, in block 812, to the ML expert.

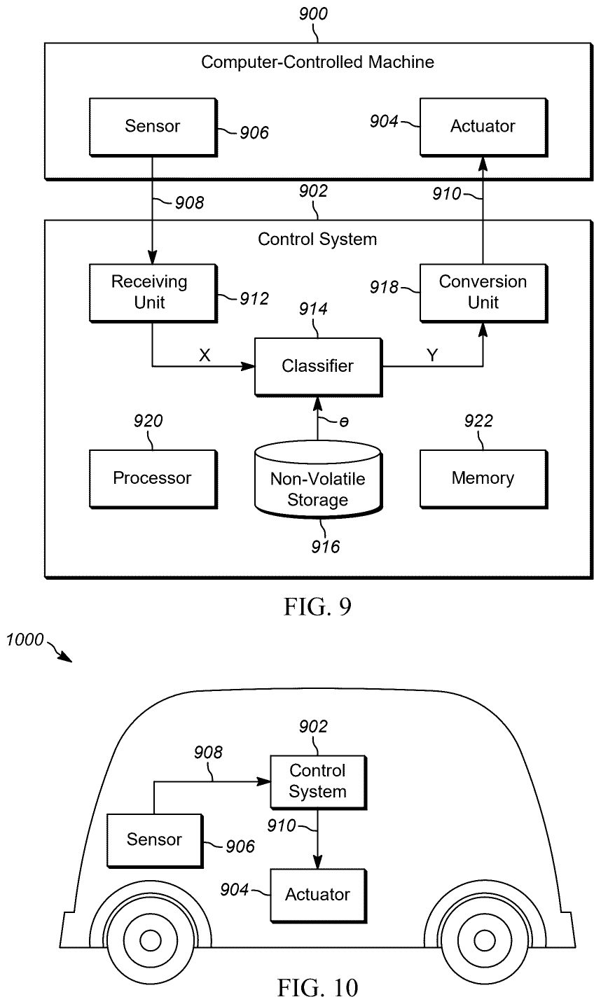

The methods and systems disclosed herein can be used in many different applications. Determining out-of-distribution data, edge cases, false positive errors, false negative errors, or other performance metric and domain-specific metrics can be useful for a plethora of technologies, examples of which are illustrated in FIGS. 9-15. FIG. 9 depicts a schematic diagram of an interaction between a computer-controlled machine 900 and a control system 902. Computer-controlled machine 900 includes actuator 904 and sensor 906. Actuator 904 may include one or more actuators and sensor 906 may include one or more sensors. Sensor 906 is configured to sense a condition of computer-controlled machine 900. Sensor 906 may be configured to sense ID and/or OOD data, and the corresponding processors can be configured to determine whether the data is ID or OOD according to the teachings herein. Sensor 906 may be configured to encode the sensed condition into sensor signals 908 and to transmit sensor signals 908 to control system 902. Non-limiting examples of sensor 906 include a camera, video sensor, radar, LiDAR, ultrasonic and motion sensors, temperature sensors, and the like. In one embodiment, sensor 906 is an optical sensor configured to sense optical images of an environment proximate to computer-controlled machine 900.

Control system 902 is configured to receive sensor signals 908 from computer-controlled machine 900. As set forth below, control system 902 may be further configured to compute actuator control commands 910 depending on the sensor signals and to transmit actuator control commands 910 to actuator 904 of computer-controlled machine 900.

As shown in FIG. 9, control system 902 includes receiving unit 912. Receiving unit 912 may be configured to receive sensor signals 908 from sensor 906 and to transform sensor signals 908 into input signals x. In an alternative embodiment, sensor signals 908 are received directly as input signals x without receiving unit 912. Each input signal x may be a portion of each sensor signal 908. Receiving unit 912 may be configured to process each sensor signal 908 to product each input signal x. Input signal x may include data corresponding to an image recorded by sensor 906.

Control system 902 includes a classifier 914. Classifier 914 may be configured to classify input signals x into one or more labels using a machine-learning algorithm, such as a neural network described above. Classifier 914 is configured to be parametrized by parameters, such as those described above (e.g., parameter θ). Parameters θ may be stored in and provided by non-volatile storage 916. Classifier 914 is configured to determine output signals y from input signals x. Each output signal y includes information that assigns one or more labels to each input signal x. Classifier 914 may transmit output signals y to conversion unit 918. Conversion unit 918 is configured to covert output signals y into actuator control commands 910. Control system 902 is configured to transmit actuator control commands 910 to actuator 904, which is configured to actuate computer-controlled machine 900 in response to actuator control commands 910. In another embodiment, actuator 904 is configured to actuate computer-controlled machine 900 based directly on output signals y.

Upon receipt of actuator control commands 910 by actuator 904, actuator 904 is configured to execute an action corresponding to the related actuator control command 910. Actuator 904 may include a control logic configured to transform actuator control commands 910 into a second actuator control command, which is utilized to control actuator 904. In one or more embodiments, actuator control commands 910 may be utilized to control a display instead of or in addition to an actuator.

In another embodiment, control system 902 includes sensor 906 instead of or in addition to computer-controlled machine 900 including sensor 906. Control system 902 may also include actuator 904 instead of or in addition to computer-controlled machine 900 including actuator 904.

As shown in FIG. 9, control system 902 also includes processor 920 and memory 922. Processor 920 may include one or more processors. Memory 922 may include one or more memory devices. The classifier 914 of one or more embodiments may be implemented by control system 902, which includes non-volatile storage 916, processor 920 and memory 922.

Non-volatile storage 916 may include one or more persistent data storage devices such as a hard drive, optical drive, tape drive, non-volatile solid-state device, cloud storage or any other device capable of persistently storing information. Processor 920 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 922. Memory 922 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. Moreover, processor 920 and memory 922 may be configured to provide collected data to one or more other computing devices that are configured to train and/or validate the machine learning model within domain-specific embodiments shown throughout FIGS. 9-15. Such collected data may be used to generate training datasets and validation datasets for various stages in preparing and executing a machine learning model into industry-grade applications. Within a context described herein with regard to edge case detection, processor 920 and memory 922 may be coupled to or otherwise remotely connected to computing devices that may then conduct validation processes such as those described above.

Processor 920 may be configured to read into memory 922 and execute computer-executable instructions residing in non-volatile storage 916 and embodying one or more machine-learning algorithms and/or methodologies of one or more embodiments. Non-volatile storage 916 may include one or more operating systems and applications. Non-volatile storage 916 may store compiled and/or interpreted from computer programs created using a variety of programming languages and/or technologies, including, without limitation, and cither alone or in combination, Java, C, C++, C#, Objective C, Fortran, Pascal, Java Script, Python, Perl, and PL/SQL.

Upon execution by processor 920, the computer-executable instructions of non-volatile storage 916 may cause control system 902 to implement one or more of the machine-learning algorithms and/or methodologies as disclosed herein. Non-volatile storage 916 may also include machine-learning data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 10 depicts a schematic diagram of control system 902 configured to control vehicle 1000, which may be an at least partially autonomous vehicle or an at least partially autonomous robot. Vehicle 1000 includes actuator 904 and sensor 906. Sensor 906 may include one or more video sensors, cameras, radar sensors, ultrasonic sensors, LiDAR sensors, and/or position sensors (e.g. GPS). One or more of the one or more specific sensors may be integrated into vehicle 1000. In the context of sign-recognition and processing as described herein, the sensor 906 is a camera mounted to or integrated into the vehicle 1000. Alternatively or in addition to one or more specific sensors identified above, sensor 906 may include a software module configured to, upon execution, determine a state of actuator 904. One non-limiting example of a software module includes a weather information software module configured to determine a present or future state of the weather proximate vehicle 1000 or other location.

Classifier 914 of control system 902 of vehicle 1000 may be configured to detect objects in the vicinity of vehicle 1000 dependent on input signals x. In such an embodiment, output signal y may include information characterizing the vicinity of objects to vehicle 1000. Actuator control command 910 may be determined in accordance with this information. The actuator control command 910 may be used to avoid collisions with the detected objects.

In embodiments where vehicle 1000 is an at least partially autonomous vehicle, actuator 904 may be embodied in a brake, a propulsion system, an engine, a drivetrain, or a steering of vehicle 1000. Actuator control commands 910 may be determined such that actuator 904 is controlled such that vehicle 1000 avoids collisions with detected objects. Detected objects may also be classified according to what classifier 914 deems them most likely to be, such as pedestrians or trees. The actuator control commands 910 may be determined depending on the classification. In a scenario where an adversarial attack may occur, the system described above may be further trained to better detect objects or identify a change in lighting conditions or an angle for a sensor or camera on vehicle 1000.

In other embodiments where vehicle 1000 is an at least partially autonomous robot, vehicle 1000 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 910 may be determined such that a propulsion unit, steering unit and/or brake unit of the mobile robot may be controlled such that the mobile robot may avoid collisions with identified objects.

In another embodiment, vehicle 1000 is an at least partially autonomous robot in the form of a gardening robot. In such embodiment, vehicle 1000 may use an optical sensor as sensor 906 to determine a state of plants in an environment proximate vehicle 1000. Actuator 904 may be a nozzle configured to spray chemicals. Depending on an identified species and/or an identified state of the plants, actuator control command 910 may be determined to cause actuator 904 to spray the plants with a suitable quantity of suitable chemicals.

Vehicle 1000 may be an at least partially autonomous robot in the form of a domestic appliance. Non-limiting examples of domestic appliances include a washing machine, a stove, an oven, a microwave, or a dishwasher. In such a vehicle 1000, sensor 906 may be an optical sensor configured to detect a state of an object which is to undergo processing by the household appliance. For example, in the case of the domestic appliance being a washing machine, sensor 906 may detect a state of the laundry inside the washing machine. Actuator control command 910 may be determined based on the detected state of the laundry.

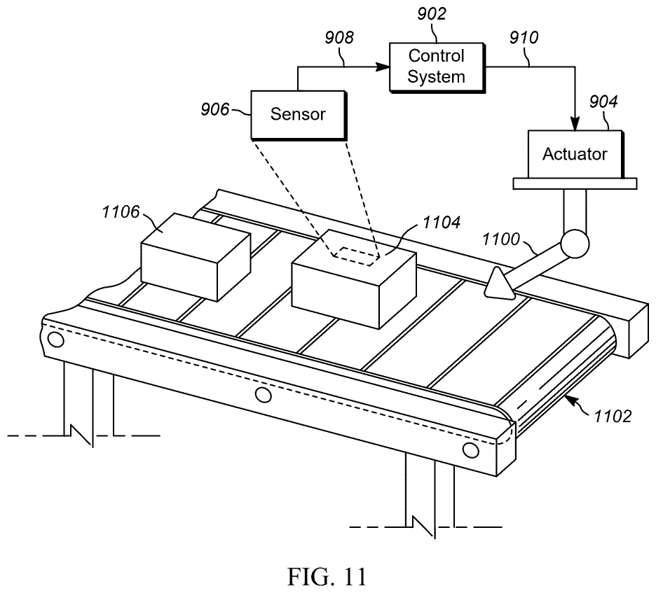

FIG. 11 depicts a schematic diagram of control system 902 configured to control system 1100 (e.g., manufacturing machine), such as a punch cutter, a cutter or a gun drill, of manufacturing system 1102, such as part of a production line. Control system 902 may be configured to control actuator 904, which is configured to control system 1100 (e.g., manufacturing machine).

Sensor 906 of system 1100 (e.g., manufacturing machine) may be an optical sensor configured to capture one or more properties of manufactured product 1104. Classifier 914 may be configured to determine a state of manufactured product 1104 from one or more of the captured properties. Actuator 904 may be configured to control system 1100 (e.g., manufacturing machine) depending on the determined state of manufactured product 1104 for a subsequent manufacturing step of manufactured product 1104. The actuator 904 may be configured to control functions of system 1100 (e.g., manufacturing machine) on subsequent manufactured product 1106 of system 1100 (e.g., manufacturing machine) depending on the determined state of manufactured product 1104.

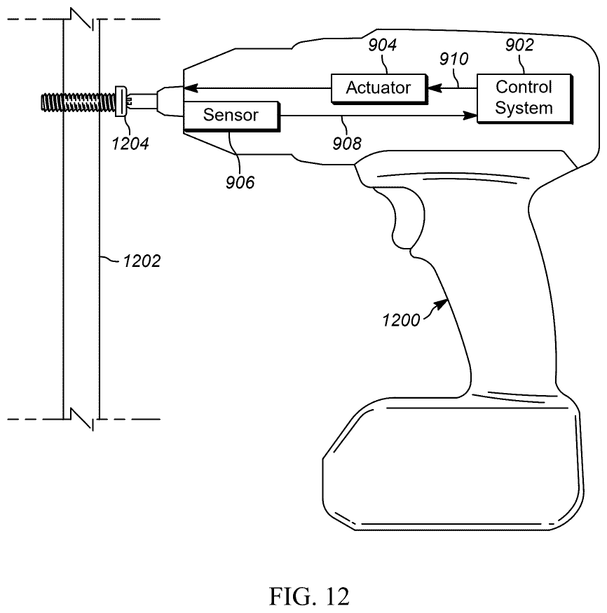

FIG. 12 depicts a schematic diagram of control system 902 configured to control power tool 1200, such as a power drill or driver, that has an at least partially autonomous mode. Control system 902 may be configured to control actuator 904, which is configured to control power tool 1200.

Sensor 906 of power tool 1200 may be an optical sensor configured to capture one or more properties of work surface 1202 and/or fastener 1204 being driven into work surface 1202. Classifier 914 within control system 902 may be configured to determine a state of work surface 1202 and/or fastener 1204 relative to work surface 1202 from one or more of the captured properties. The state may be fastener 1204 being flush with work surface 1202. The state may alternatively be hardness of work surface 1202. Actuator 1204 may be configured to control power tool 1200 such that the driving function of power tool 1200 is adjusted depending on the determined state of fastener 1204 relative to work surface 1202 or one or more captured properties of work surface 1202. For example, actuator 1204 may discontinue the driving function if the state of fastener 1204 is flush relative to work surface 1202. As another non-limiting example, actuator 1204 may apply additional or less torque depending on the hardness of work surface 1202.

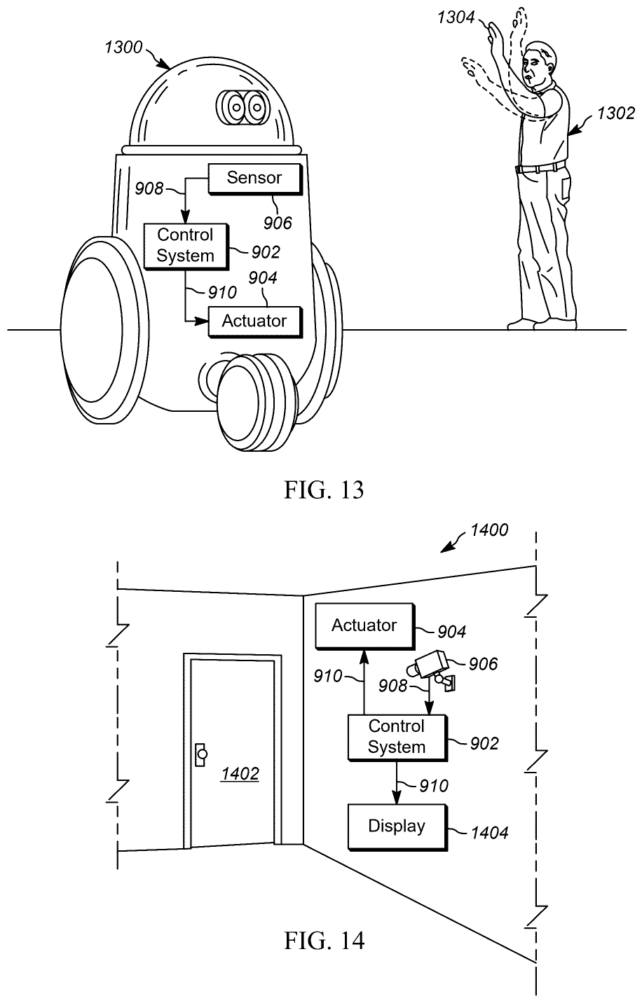

FIG. 13 depicts a schematic diagram of control system 902 configured to control automated personal assistant 1300. Control system 902 may be configured to control actuator 904, which is configured to control automated personal assistant 1300. Automated personal assistant 1300 may be configured to control a domestic appliance, such as a washing machine, a stove, an oven, a microwave or a dishwasher.

Sensor 906 may be an optical sensor and/or an audio sensor. The optical sensor may be configured to receive video images of gestures 1304 of user 1302. The audio sensor may be configured to receive a voice command of user 1302.

Control system 902 of automated personal assistant 1300 may be configured to determine actuator control commands 910 configured to control system 902. Control system 902 may be configured to determine actuator control commands 910 in accordance with sensor signals 908 of sensor 906. Automated personal assistant 1300 is configured to transmit sensor signals 908 to control system 902. Classifier 914 of control system 902 may be configured to execute a gesture recognition algorithm to identify gesture 1304 made by user 1302, to determine actuator control commands 910, and to transmit the actuator control commands 910 to actuator 904. Classifier 914 may be configured to retrieve information from non-volatile storage in response to gesture 1304 and to output the retrieved information in a form suitable for reception by user 1302.

FIG. 14 depicts a schematic diagram of control system 902 configured to control monitoring system 1400. Monitoring system 1400 may be configured to physically control access through door 1402. Sensor 906 may be configured to detect a scene that is relevant in deciding whether access is granted. Sensor 906 may be an optical sensor configured to generate and transmit image and/or video data. Such data may be used by control system 902 to detect a person's face.

Classifier 914 of control system 902 of monitoring system 1400 may be configured to interpret the image and/or video data by matching identities of known people stored in non-volatile storage 916, thereby determining an identity of a person. Classifier 914 may be configured to generate and an actuator control command 910 in response to the interpretation of the image and/or video data. Control system 902 is configured to transmit the actuator control command 910 to actuator 904. In this embodiment, actuator 904 may be configured to lock or unlock door 1402 in response to the actuator control command 910. In other embodiments, a non-physical, logical access control is also possible.

Monitoring system 1400 may also be a surveillance system. In such an embodiment, sensor 906 may be an optical sensor configured to detect a scene that is under surveillance and control system 902 is configured to control display 1404. Classifier 914 is configured to determine a classification of a scene, e.g. whether the scene detected by sensor 906 is suspicious. Control system 902 is configured to transmit an actuator control command 910 to display 1404 in response to the classification. Display 1404 may be configured to adjust the displayed content in response to the actuator control command 910. For instance, display 1404 may highlight an object that is deemed suspicious by classifier 914. Utilizing an embodiment of the system disclosed, the surveillance system may predict objects at certain times in the future showing up.

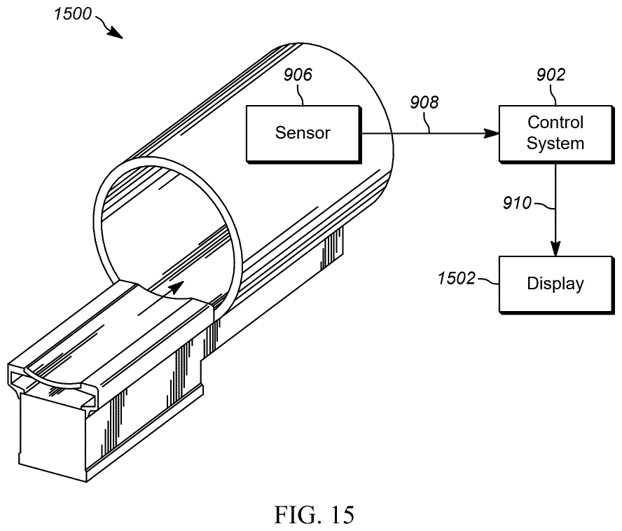

FIG. 15 depicts a schematic diagram of control system 902 configured to control imaging system 1500, for example an MRI apparatus, x-ray imaging apparatus or ultrasonic apparatus. Sensor 906 may, for example, be an imaging sensor. Classifier 914 may be configured to determine a classification of all or part of the sensed image. Classifier 914 may be configured to determine or select an actuator control command 910 in response to the classification obtained by the trained neural network. For example, classifier 914 may interpret a region of a sensed image to be potentially anomalous. In this case, actuator control command 910 may be determined or selected to cause display 1502 to display the imaging and highlighting the potentially anomalous region.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for a machine learning network, comprising:
providing a validation dataset to a principal machine learning model, wherein the validation dataset comprises data samples and associated ground truth labels;
executing the principal machine learning model to generate predictions associated with the data samples of the validation dataset;
determining sample outcomes for each of the data samples, wherein the sample outcomes indicate correct predictions or incorrect predictions of the principal machine learning model with respect to the associated ground truth labels;
identifying slices associated with the validation dataset, wherein respective ones of the slices comprise two or more of the data samples;
training a shallow learning model to simulate updated sample outcomes of the principal machine learning model given a retraining of the principal machine learning model using a training dataset associated with a given one of the identified slices, wherein the training the shallow learning model comprises:
modifying the determined sample outcomes for the given one of the identified slices, such that each of the determined sample outcomes corresponds to the data samples within the given one of the identified slices is associated with a correct prediction;
providing the modified sample outcomes and the validation dataset to the shallow learning model;
executing the shallow learning model to simulate the updated sample outcomes; and
determining quantitative positive, negative, or neutral effects on respective other ones of the identified slices using the simulated, updated sample outcomes in comparison to the determined sample outcomes; and
displaying, via a user interface, the quantitative positive, negative, or neutral effects to a user of the machine learning network.

2. The computer-implemented method of claim 1, further comprising:
receiving an indication from the user to retrain the principal machine learning model based, at least in part, on the given one of the identified slices;
generating a subsequent training dataset based, at least in part, on the data samples within the given one of the identified slices;
providing the subsequent training dataset to the principal machine learning model; and
executing the principal machine learning model to generate updated predictions associated with the subsequent training dataset.

3. The computer-implemented method of claim 1, wherein:
the method further comprises extracting sample-level embedding features that correspond to the data samples of the validation dataset; and
the training of the shallow learning model further comprises providing the modified sample outcomes and the sample-level embedding features to the shallow learning model.

4. The computer-implemented method of claim 1, wherein:
the method further comprises extracting detection-level embedding features that correspond to the data samples of the validation dataset; and
the training of the shallow learning model further comprises providing the modified sample outcomes and the detection-level embedding features to the shallow learning model.

5. The computer-implemented method of claim 1, wherein:
the validation dataset further comprises metadata features; and
the training of the shallow learning model further comprises providing the modified sample outcomes and the metadata features to the shallow learning model.

6. The computer-implemented method of claim 1, wherein the training of the shallow learning model further comprises applying an importance weighting that is biased towards the data samples in the given one of the identified slices during the executing the shallow learning model.

7. The computer-implemented method of claim 1, wherein the training of the shallow learning model further comprises applying a group distributionally robust optimization during the executing the shallow learning model.

8. The computer-implemented method of claim 1, wherein the shallow learning model is a gradient boosting decision-tree-based model or a random forest decision-tree-based model.

9. The computer-implemented method of claim 1, wherein the shallow learning model is a support vector network or a shallow neural network.

10. The computer-implemented method of claim 1, wherein the principal machine learning model is a classification model, an object detection model, or a regression model.

11. The computer-implemented method of claim 1, wherein the data samples of the validation dataset are indicative of image information, tabular information, radar information, sonar information, or sound information.

12. A system, comprising:
one or more processors; and
memory having program instructions that, when executed by the one or more processors, cause the one or more processors to:
provide a validation dataset to a principal machine learning model, wherein the validation dataset comprises data samples and associated ground truth labels;
execute the principal machine learning model to generate predictions associated with the data samples of the validation dataset;
determine sample outcomes for each of the data samples, wherein the sample outcomes indicate correct predictions or incorrect predictions of the principal machine learning model with respect to the associated ground truth labels;
identify slices associated with the validation dataset, wherein respective ones of the slices comprise two or more of the data samples;
train a shallow learning model to simulate updated sample outcomes of the principal machine learning model given a retraining of the principal machine learning model using a training dataset associated with a given one of the identified slices, wherein the training of the shallow learning model comprises:
modify the determined sample outcomes for the given one of the identified slices, such that each of the determined sample outcomes corresponds to the data samples within the given one of the identified slices is associated with a correct prediction;
provide the modified sample outcomes and the validation dataset to the shallow learning model;
execute the shallow learning model to simulate the updated sample outcomes; and
determine quantitative positive, negative, or neutral effects on respective other ones of the identified slices using the simulated, updated sample outcomes in comparison to the determined sample outcomes; and
display, via a user interface, the quantitative positive, negative, or neutral effects to a user.

13. The system of claim 12, wherein the program instructions further cause the one or more processors to:
receive an indication from the user to retrain the principal machine learning model based, at least in part, on the given one of the identified slices;
generate a subsequent training dataset based, at least in part, on the data samples within the given one of the identified slices;
provide the subsequent training dataset to the principal machine learning model; and
execute the principal machine learning model to generate updated predictions associated with the subsequent training dataset.

14. The system of claim 12, wherein:
the validation dataset further comprises one or more of:
metadata features;
sample-level embedding features that correspond to the data samples of the validation dataset; or
detection-level embedding features that correspond to the data samples of the validation dataset; and
to train the shallow learning model, the program instructions further cause the one or more processors to provide the modified sample outcomes and the validation dataset to the shallow learning model.

15. The system of claim 12, wherein the program instructions further cause the one or more processors to train the shallow learning model based, at least in part, on an application of an importance weighting that is biased towards the data samples in the given one of the identified slices.

16. The system of claim 12, wherein the program instructions further cause the one or more processors to train the shallow learning model based, at least in part, on a group distributionally robust optimization.

17. One or more non-transitory, computer-readable media storing program instructions that, when executed on or across one or more processors, cause the one or more processors to:
receive a combined dataframe, wherein the combined dataframe comprises:
data samples of a validation dataset;
associated ground truth labels; and
predictions, generated by a principal machine learning model;
determine sample outcomes for each of the data samples, wherein the sample outcomes indicate correct predictions or incorrect predictions of the principal machine learning model with respect to the associated ground truth labels;
identify slices associated with the validation dataset, wherein respective ones of the slices comprise two or more of the data samples;
train a shallow learning model to simulate updated sample outcomes of the principal machine learning model given a retraining of the principal machine learning model using a training dataset associated with a given one of the identified slices, wherein the training of the shallow learning model comprises:
modify the determined sample outcomes for the given one of the identified slices, such that each of the determined sample outcomes corresponds to the data samples within the given one of the identified slices is associated with a correct prediction;
provide the modified sample outcomes and the validation dataset to the shallow learning model;
execute the shallow learning model to simulate the updated sample outcomes; and
determine quantitative positive, negative, or neutral effects on respective other ones of the identified slices using the simulated, updated sample outcomes in comparison to the determined sample outcomes; and
display, via a user interface, the quantitative positive, negative, or neutral effects to a user.

18. The one or more non-transitory, computer-readable media of claim 17, wherein the program instructions further cause the one or more processors to train the shallow learning model based, at least in part, on an application of an importance weighting that is biased towards the data samples in the given one of the identified slices.

19. The one or more non-transitory, computer-readable media of claim 17, wherein the program instructions further cause the one or more processors to train the shallow learning model based, at least in part, on a group distributionally robust optimization.

20. The one or more non-transitory, computer-readable media of claim 17, wherein the program instructions further cause the one or more processors to:
provide the validation dataset to the principal machine learning model;
execute the principal machine learning model to generate the predictions associated with the data samples of the validation dataset; and
generate the combined dataframe for the training of the shallow learning model.
